(19) United States
(12) Patent Application Publication
(10) Pub. No.: US 2019/0302884 A1
(43) Pub. Date: Oct. 3, 2019

(54) DETERMINATION AND USAGE OF GAZE TRACKING DATA

(71) Applicant: Tobii AB, Danderyd (SE)

(72) Inventor: Erik Alsmyr, Danderyd (SE)

(73) Assignee: Tobii AB, Danderyd (SE)

(21) Appl. No.: 16/367,556

(22) Filed: Mar. 28, 2019

Related U.S. Application Data
(60) Provisional application No. 62/649,439, filed on Mar. 28, 2018.

(51) Int. Cl. G06F 3/01; G06K 9/00

(52) U.S. Cl. CPC G06F 3/013; G06K 2209/21; G06K 9/00671

(57) ABSTRACT

Methods and corresponding systems of for the collection, transportation and analysis of attention data is disclosed. The system includes a gaze determination device, a beacon, an attention data processing engine, and a correlation engine that receives the attention data to generate correlated attention data. In the methods, correlated attention data is used to modify a content that is provided to the user in real time and is used to modify that audience of users that the content is provided to.

### FIELD OF INVENTION

The present invention generally relates to systems and methods for determining a user's attention towards an item, and in particular, to systems and methods for using gaze tracking data to determine a user's attention.

### BACKGROUND OF THE INVENTION

With the advent and rise of gaze tracking technology, such as that provided by the applicant Tobii AB, it is possible to determine when a user is gazing towards an item. Furthermore, in visual media, for example, people reliably attend to the visual information to which their gaze is directed. As a result, gaze tracking technology can be used for attention detection in the visual media.

Gaze tracking technology typically comprises at least one image sensor and at least one infrared illuminator. The infrared illuminator directs infrared illumination towards the eye of a user, and the image sensor captures an image of the eye. A processor then determines, based on the captured image, a gaze direction of the user. The technology used to determine a user's gaze direction is not the subject of the present invention, and will not be described in detail.

Although it has been previously described how to use a user's gaze information to determine the attention or interest level of a user (see U.S. Pat. No. 7,120,880 which is hereby incorporated by reference in its entirety), a central computer system that provides computing services based on gaze information of multiple users has not been previously described.

It is an object of the present invention to describe such a system and components thereof.

### SUMMARY OF THE INVENTION

An object of the present invention is to provide a system that provides computing services based on gaze information of multiple users. This system generates new data from the gaze information, where the new data supports the customization of online services at a level not previously achievable.

The inventive system allows for the processing and real time modification of content being viewed by a user based upon Attention data analysis that is performed by the system. Furthermore, by allowing for the use of multiple beacons, multiple objects of attention may be analyzed as a part of the inventive system.

This and other objects of the present invention will be made apparent from the specification and claims together with appended drawings. According to different aspects of the invention there are provided systems and methods for the collection, transportation and analysis of attention data. According to further aspects, there are provided a computer program, and a computer program product comprising a computer-readable storage medium, comprising computer-executable instructions for causing a computer system, when the computer-executable instructions are executed on a processing unit comprised in the computer system, to perform operations according to any of the method embodiments presented herein.

### BRIEF DESCRIPTION OF THE DRAWINGS

Exemplifying embodiments will be described below with reference to the accompanying drawings, in which:

FIG. 1 depicts an embodiment of the system for collecting, transporting and analyzing attention data;

FIG. 2 depicts a diagram of applications of the analyzed attention data.

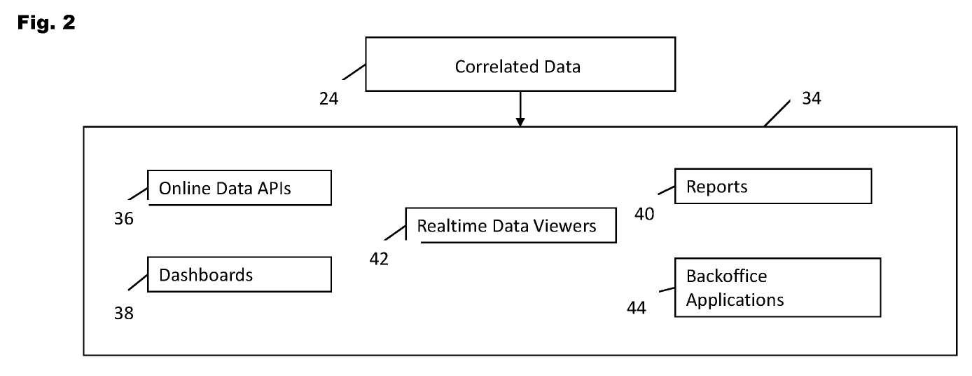

FIG. 3 depicts a flow diagram of a method of operation of the present invention.

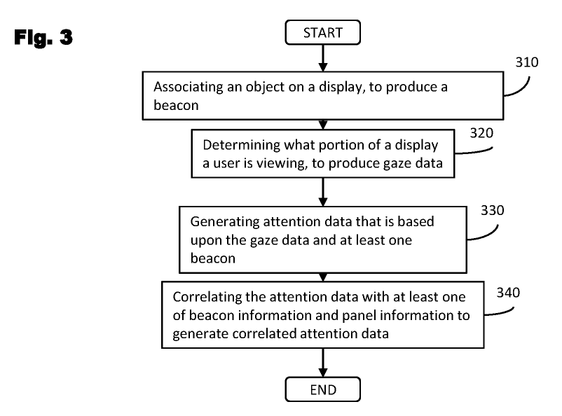

### DESCRIPTION

According to a first aspect of the present invention, there is provided a system for the collection, transportation and analysis of attention data. The term “attention data” and similar when used in this document is intended to refer to any type of information, variable, representation and the like which can, with or without analysis, be used by a person to conclude a subject's attention with regards to a particular item. By way of example only, attention data may be gaze information determined by a gaze determination device which determines a user's gaze direction relative to a display, or portion of a display.

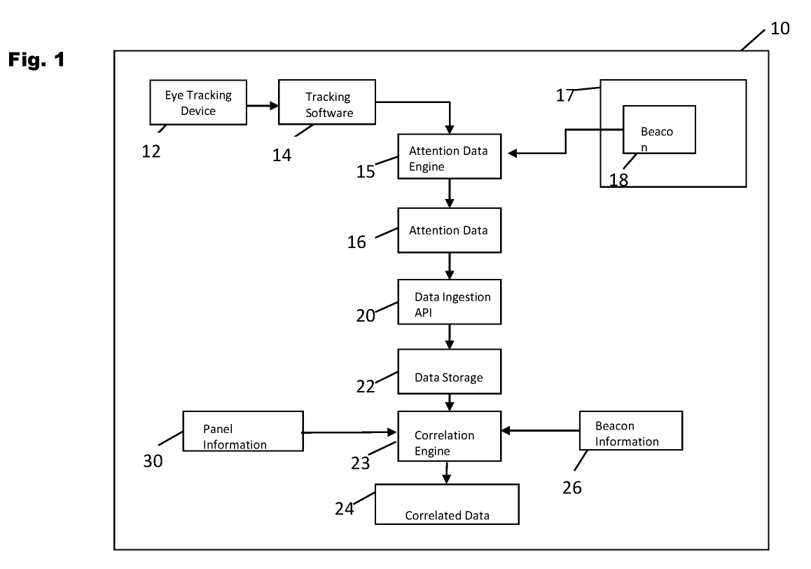

With reference to FIG. 1, a system 10 according to a first aspect of the present invention will now be described. Attention data 16 is derived from an eye tracking device 12 in communication with eye tracking software 14, as well as a beacon 18 embedded within an operating system, application, website or other similar software 17, through the use of an attention data engine 15. The attention data engine 15 receives and processes the gaze information from the eye tracking device 12, as well as beacon information from the beacon 18. The beacon 18 may be associated with any manner of object, for example an image, text, video, software code, etc. The beacon 18 is an entity that tags an object such that gaze data relative to that object may be gathered. By way of example, the beacon could be associated with an object in a 3D game environment such as Unity™ content on a website, an image within a video, etc.

A beacon comes in one of two forms, an explicit beacon or an implicit beacon. An explicit beacon is a beacon that has been defined by a user, programmer or other individual. For example, it may be code inserted into a program, an extension in a web browser, etc. An implicit beacon is a beacon that is identified via an automated means, for example all instances of a particular word could be assigned a beacon.

Attention data 16 is a reflection of gaze information from an eye tracking device 12, relative to one or more Beacons 18. The attention data may include, but is not limited to:

time from exposure of an object associated with a beacon, until it is gazed upon, how many times an object associated with a beacon is gazed upon, and/or the total duration of gazes towards a beacon.

The eye tracking device 12 and eye tracking software 14 analyze the contents of a display to determine the attention data 16. Objects on a display that are associated with beacons 18 may be determined by the eye tracking software 14 to exist in a hierarchy. Multiple items may be layered one atop the other, for example, text upon a logo. The eye tracking software 12 may use this hierarchy to dynamically determine the subject of a user's gaze.

The attention data 16 is then communicated to a data ingestion API (application program interface) 20, the data ingestion API 20 converts the attention data 16 into a format such that the attention data 16 may be stored in primary attention data storage 22. The primary attention data storage 22 and data ingestion API 20 may be remote from the attention data 16, or may be also located on the same device as the attention data 16.

The stored data is then sent from the primary attention data storage 22 to a correlation engine 23, where it is combined with other data to generate correlation data 24. The other data includes, for example, beacon information 26, which is defined by beacon management applications, and panel information 30, which is defined by panel management applications. It is understood that the correlation data may also be processed with other data useful in analyzing a user's attention of the beacons.

The correlated data 24 may be requested and sent to specific applications, devices and services 34, including online data, APIs 36, dashboards 38, reports 40 and other applications. The correlated data 24 may also be viewed in real time through the use of the real time viewer 42, and actions adopted manually or automatically according to this real time information. For example, a user may define that once first content has been viewed 40% more often than second content, the first content is changed.

Further, back office applications 44 can be used to define customers, create API keys, manage end users and the like, this information feeds into (along with information from the beacon management applications and panel management applications), and is used by, specific applications, devices and services 34.

Panel management applications 32 is a suite of services used to define panels (for example panel information 30), define types of information to be viewed by the panels, and view the results of panel viewing. A panel is a collection of individuals. A panel may have specific common interests or traits, for example men between the age of 25 and 30, or people who play a specific video game. The members of the panel may determine to only participate in regards to certain types of beacons, for example, an individual may determine to only participate in the gathering of gaze information when playing a specific video game.

Beacon management applications 28 are used to define beacon types, beacon locations, and distribute beacons to specific objects. Further, Beacon management applications may be used to view statistics regarding gaze towards individual beacons, or beacon types.

Beacons will now be further described in the context of the present invention.

A beacon 18 is a virtual item, defined by software code. It may be associated with any manner of object, for example, an image, text, video, software code, etc. The beacon 18 is an entity that tags an object such that gaze data relative to that object may be gathered. By way of example, the beacon could be associated with an object in a 3D game environment such as Unity™ content on a website, an image within a video, etc.

A beacon comes in one of two forms, an explicit beacon or an implicit beacon. An explicit beacon is a beacon that has been defined by a user, programmer or other individual. For example, it may be code inserted into a program, an extension in a web browser, etc. An implicit beacon is a beacon that is identified via an automated means, for example, all instances of a particular word could be assigned a beacon.

In one embodiment a beacon may operate in push mode, that is to say they have the ability to transmit data of their own accord, rather than transmit data only in response to a request. Beacons transmit information about whether their associated object has been viewed, this includes some or all of the following information:
the system the object was viewed on,
the area of the object that was viewed,
a screenshot, or recording of the object at the time it was viewed,
information about the viewer of the object, such as demographic information,
the duration of the view of the object, and
the frequency of the view of the object.

Different levels of view information may be transmitted by the beacon, these levels include:
whether the object was visible to a user,
whether the object was seen by a user,
raw gaze data (such as gaze coordinates over time), and
the context of the viewing of the object, including a screenshot or recording.

This information may include the user's state when viewing an object, for example was the user happy, confused, sad, etc. This information may be determined, in a vision based system, through computer vision and analysis of features on a user's face.

Alternatively, this information could be determined by items such as a user's browsing history, previous viewing information, etc.

Data may be delivered in a multiple of different formats, from text based reports, to graphical presentations. The exact format of data delivery is not the subject of the present invention, however the content of the data delivery is one aspect of the present invention.

The delivered data may include one, or all of the following:
The relation between cost of viewing content and visual engagement. For example, how long is a content viewed? Does a user return to view the same content a second time?
The time taken between the point a content becomes capable of being viewed by a user, and is actually viewed by a user.
The length of fixation of a user upon a content, this may be represented relative to the size of the screen and the size of the content.
The number of times a user views a content.

This data may be delivered for a single user, multiple users, or subsets of users.

In an example, the content includes targeted content (e.g., advertisement) presented on a graphical user interface of a computing device.

In order to identify users for demographic purposes, information can be gathered in a multitude of ways. This could include information volunteered by a user, serial numbers for computer hardware, IP addresses, internet browser information, cookies, and browser history.

According to one aspect of the present invention, the system may be used to optimize displayed items such as content, multimedia, and the like. By way of example, the aspect will be described with reference to viewing content, such as targeted content. Traditionally, determination of which content to display for a particular good or service is performed by testing various content on a focus group of people, and selecting single content to then display to all people.

According to this aspect of the present invention, this may be avoided by distributing multiple content for a good or service through the system. A content provider (e.g., an advertiser) may then utilize the back office applications 44 to define demographics of users to see different contents. These demographics may include age, income, viewing habits, technology owned, and the like.

The system may then take the information defined in the back office applications 44, to distribute content to multiple devices. The viewing of particular content by a user, as evidenced by eye tracking data, may then modify the next instance of the content to the same user. For example, if a user has already viewed targeted content for a particular good or service, the next instance of displaying content may show different targeted content for the same good or service.

Data may be collected regarding the viewing habits related to content for particular users and demographics, and then that data may be used to alter content shown to other demographics. For example, if the data indicates that particular content is viewed often by a particular demographic (demographic A), and historically content that is viewed often by demographic A is also viewed often by a second demographic (demographic B), then the system may be used to distribute that content to demographic B.

According to another aspect of the invention, there is provided a method for determining a user's attention towards an item and using the data collected from determining the user's attention, the method comprising:
In step 310: associating an object on a display, to produce a beacon.
In step 320: determining what portion of a display a user is viewing, to produce gaze data.
In step 330: generating attention data that is based upon the gaze data and at least one beacon.
In step 340: correlating the attention data with at least one of beacon information and panel information to generate correlated attention data, wherein the beacon information is defined by a beacon management application and the panel information is defined by a panel management application.

The method may further comprise associating the object to the beacon by an explicit instruction. Alternatively, or in combination, the method may comprise associating the object to the beacon by an automated function.

In one or more embodiments, the method comprises associating the beacon to at least one of an object in a 3D game, content on a website, and an image within a video.

In one or more embodiments, the method comprises: transmitting the correlated attention data to a content providing application; and modifying content output provided by the content providing application based upon the correlated attention data. The method may then further comprise displaying modified content to the user and/or selecting a group of additional users based upon the correlated attention data and displaying the modified content to the additional users.

In some embodiments, there is provided a computer program comprising computer-executable instructions for causing a computer system, when the computer-executable instructions are executed on a processing unit comprised in the computer system, to perform operations according to any of the method embodiments presented herein. In further embodiments, there is provided a computer program product comprising a computer-readable storage medium, the computer-readable storage medium having the computer program according to any of the above embodiments embodied therein.

A person skilled in the art realizes that the present invention is by no means limited to the preferred embodiments described above. On the contrary, many modifications and variations are possible within the scope of the appended claims. Additionally, variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The division of tasks between functional units referred to in the present disclosure does not necessarily correspond to the division into physical units; to the contrary, one physical component may have multiple functionalities, and one task may be carried out in a distributed fashion, by several physical components in cooperation. A computer program may be stored/distributed on a suitable non-transitory medium, such as an optical storage medium or a solid-state medium supplied together with or as part of other hardware, but may also be distributed in other forms, such as via the Internet or other wired or wireless telecommunication systems. The mere fact that certain measures/features are recited in mutually different dependent claims does not indicate that a combination of these measures/features cannot be used to advantage. Method steps need not necessarily be performed in the order in which they appear in the claims or in the embodiments described herein, unless it is explicitly described that a certain order is required. Any reference signs in the claims should not be construed as limiting the scope.

1. A system for the collection, transportation and analysis of attention data, the system comprising:
a gaze determination device, wherein the gaze determination device generates gaze information that is based upon a user's gaze direction relative to at least a portion of a display,
a beacon, wherein the beacon is associated with an object on the display,
an attention data engine that generates attention data based upon the gaze information and at least one beacon, and
a correlation engine that receives the attention data and at least one of beacon information and panel information to generate correlated attention data, wherein the beacon information is defined by a beacon management application and the panel information is defined by a panel management application.

2. The system for the collection, transportation and analysis of attention data of claim 1, wherein the beacon is associated with the object by an explicit instruction.

3. The system for the collection, transportation and analysis of attention data of claim 1, wherein the beacon is associated with the object by an automated function.

4. The system for the collection, transportation and analysis of attention data of claim 1, wherein the beacon is associated with at least one of an object in a 3D game, content on a website, and an image within a video.

5. The system for the collection, transportation and analysis of attention data of claim 1, further comprising a content providing application, wherein the content providing application receives the correlated attention data and modifies content output it provides based upon the correlated attention data.

6. The system for the collection, transportation and analysis of attention data of claim 5, wherein modified content output is provided to the user.

7. The system for the collection, transportation and analysis of attention data of claim 5, wherein modified content output is provided to additional users.

8. A method for determining a user's attention towards an item and using the data collected from determining the user's attention, the method comprising:
associating an object on a display, to produce a beacon;
determining what portion of a display a user is viewing, to produce gaze data;
generating attention data that is based upon the gaze data and at least one beacon; and
correlating the attention data with at least one of beacon information and panel information to generate correlated attention data, wherein the beacon information is defined by a beacon management application and the panel information is defined by a panel management application.

9. The method for determining and using the data collected from determining the user's attention of claim 8, further comprising associating the object to the beacon by an explicit instruction.

10. The method for determining and using the data collected from determining the user's attention of claim 8, further comprising associating the object to the beacon by an automated function.

11. The method for determining and using the data collected from determining the user's attention of claim 8, further comprising associating the beacon to at least one of an object in a 3D game, content on a website, and an image within a video.

12. The method for determining and using the data collected from determining the user's attention of claim 8, further comprising:
transmitting the correlated attention data to a content providing application;
modifying content output provided by the content providing application based upon the correlated attention data.

13. The method for determining and using the data collected from determining the user's attention of claim 12, further comprising displaying modified content to the user.

14. The method for determining and using the data collected from determining the user's attention of claim 12, further comprising:
selecting a group of additional users based upon the correlated attention data;
displaying the modified content to the additional users.
